(19) United States
(12) Patent Application Publication
(10) Pub. No.: US 2008/0150387 A1
(43) Pub. Date: Jun. 26, 2008

(54) Rotatable magnetic device

(76) Inventor: Jeh-Wei Chao, Banciao City (TW)

Correspondence Address: JACKSON WALKER, L.L.P., 112 E. PECAN, SUITE 2400, SAN ANTONIO, TX, 78205, US

(21) Appl. No.: 11/643,275

(22) Filed: Dec. 21, 2006

(51) Int. Cl. H02K 13/02; H02K 23/26; H01R 39/08

(52) U.S. Cl. 310/198; 310/232; 310/143; 310/261

(57) ABSTRACT

A rotatable magnetic device has a housing, a shaft, a stator, a rotor and a cord. The housing is hollow and has an inner wall. The shaft is mounted coaxially and rotatably in the housing. The stator is mounted on the inner wall of the housing. The rotor is mounted on the shaft and has a polarity that causes the repelling magnetic force from the stator to rotate the rotor, which drives the shaft to rotate simultaneously.

### BACKGROUND OF THE INVENTION

1. Field of the Invention

The present invention relates to a rotatable device, and more particularity to a rotatable magnetic device that uses repelling magnetic forces to rotate a shaft in the rotatable magnetic device so that the shaft can be rotated without applying an external force.

2. Description of Related Art

A conventional rotatable device such as generators in accordance with the prior art has a housing, a stator, a shaft, a rotor, a coil and a commutator.

The housing is hollow and has an inner wall.

The stator has multiple permanent magnets. Each permanent magnet is mounted on the inner wall of the housing and has a magnetic field.

The shaft is mounted coaxially and rotatably in the housing and has an end and is rotated by an external force.

The rotor is mounted around the shaft and has an outer surface.

The coil is wound on the outer surface of the rotor and passes through the magnet fields of the permanent magnets when the shaft rotates.

The commutator is mounted on the end of the shaft, is connected to the coil and has multiple brushes. The brushes are mounted on the commutator and picks up and rectifies current generated in the coil when the shaft rotates.

When the external force stops acting on the shaft, the shaft stops rotating, and the rotatable device stops function or generating electricity. Furthermore, another power source is required to generate the external force needed to rotate the shaft, and the generator is not perfectly efficient so some of the other power source is wasted.

To overcome the shortcomings, the present invention provides a rotatable magnetic device to obviate or mitigate the aforementioned problems.

### SUMMARY OF THE INVENTION

The primary objective of the present invention is to provide a rotatable magnetic device that uses repelling magnetic forces to rotate a shaft in the rotatable magnetic device so no external force is required to rotate the shaft.

The rotatable magnetic device has a housing, a shaft, a stator, a rotor and a cord. The housing is hollow and has an inner wall. The shaft is mounted rotatably and coaxially in the housing. The stator is mounted on the inner wall of the housing and has a polarity. The rotor is mounted on the shaft and has a polarity that causes the repelling magnetic force from the stator to rotate the rotor, which drives the shaft to rotate simultaneously.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a rotatable magnetic device in accordance with the present invention;

FIG. 2 is a perspective view of the rotatable magnetic device in FIG. 1 with the housing being removed;

FIG. 3 is a front view in partial section of the rotatable magnetic device in FIG. 1;

FIG. 4 is a perspective view of electrical elements of a rotor of the rotatable magnetic device in FIG. 1;

FIG. 5 is a perspective view of a second embodiment of a rotatable magnetic device in accordance with the present invention; and

FIG. 6 is a perspective view of electrical elements of a rotor of the rotatable magnetic device in FIG. 5.

### DETAILED DESCRIPTION OF THE PREFERRED EMBODIMENT

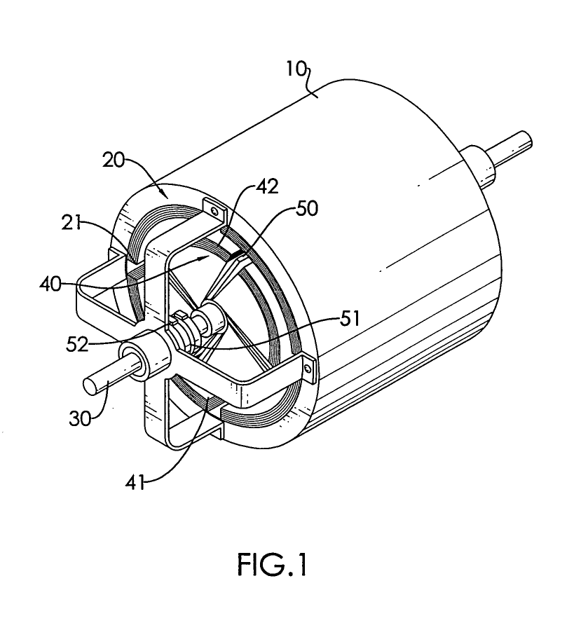

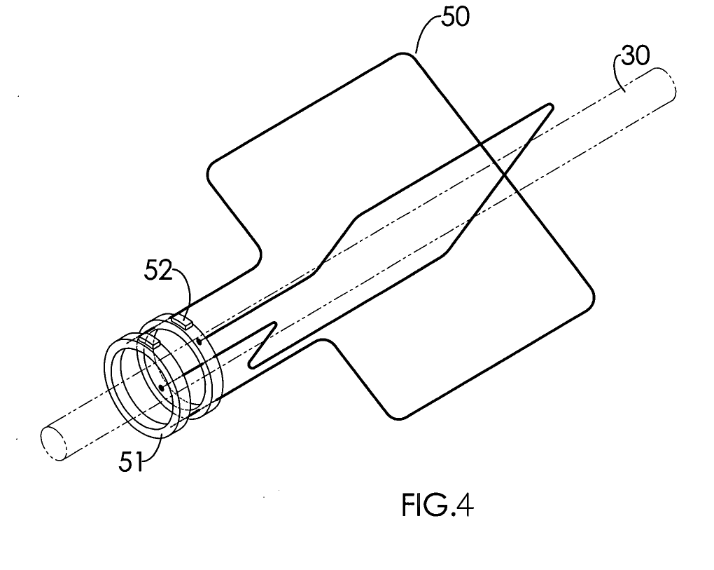

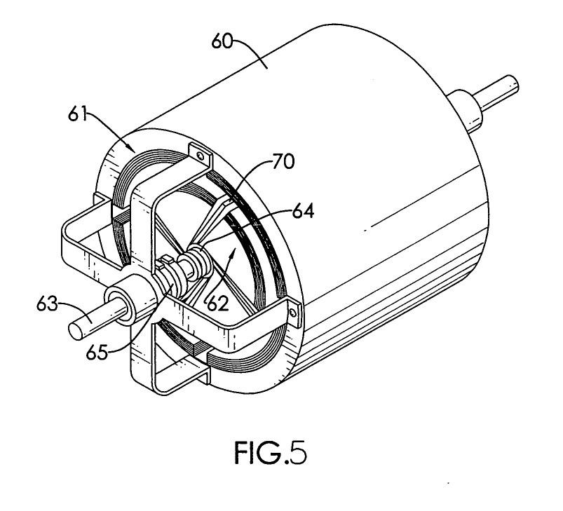

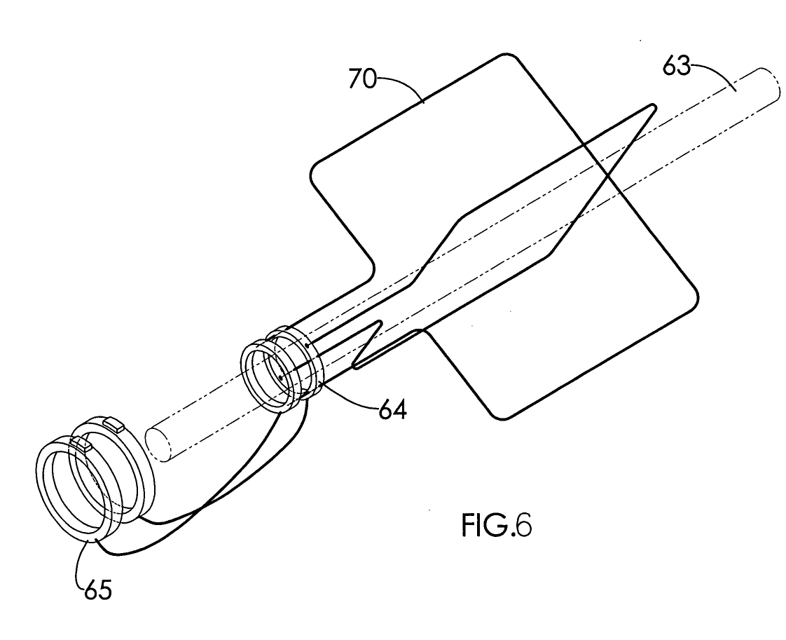

With reference to FIGS. 1, 4, 5 and 6, a rotatable magnetic device in accordance with the present invention has a housing (10, 60), a stator (20, 61), a shaft (30, 63), a rotor (40, 62), a coil (22, 42), optional rings (64), an optional commutator (51,65), a cord (50,70) and optional brushes (52).

The housing (10,60) is hollow and has an inner wall.

The stator (20, 61) has multiple magnetic pieces (21). Each magnetic piece (21) may be a permanent magnet or a temporary magnet and rectangle-shape and is mounted on the inner wall of the housing (10, 60) and has a side wall and a polarity and magnetic field.

The shaft (30, 63) is mounted coaxially and rotatably in the housing (10)(60) and has an end and a side and a center.

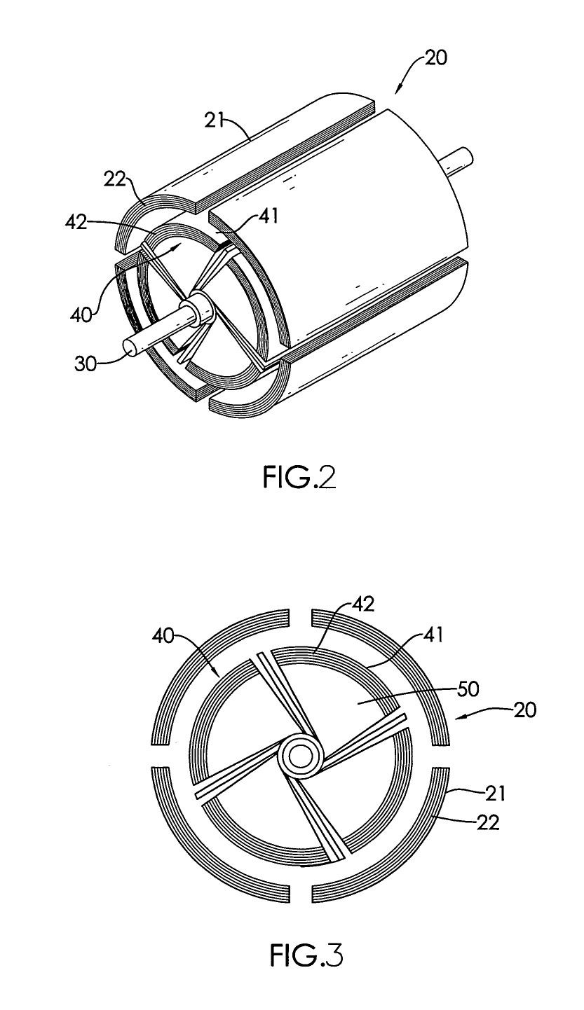

With further reference to FIGS. 2 and 3, the rotor (40, 62) has multiple magnetic pieces (41). Each magnetic piece (41) may be a temporary magnet or a permanent magnet, is mounted around the side of the shaft (30,63) and corresponded to the center of the shaft (30,63) with certain degrees slanting, corresponds to and replies the magnetic pieces (21) of the stator (20) and has a side wall and a magnetic field and a polarity that causes the repelling magnetic force from the stator (20, 61) to rotate the rotor (40, 62). The magnetic piece (41) of the rotor (40, 61) is not alignment to each other so that the magnetic force of the corresponded magnetic pieces (41) of the rotor (40, 61) can not cancel each other and a rotational torque is applied to the shaft (30,63) may be generated so that the rotor (40, 62) may drive the shaft (30, 63) to rotate simultaneously.

The coil (22) is wounded on the side walls of the magnetic pieces (21) of the stator (20, 61) and may be connected to a power source and increase the magnetic fields of the magnetic pieces (21) of the stator (20, 61).

The coil (42) is coiled on the side walls of the magnetic pieces (41) of the rotor (40, 62) and may be connected to a power source and increase the magnetic fields of the magnetic pieces (41) of the rotor (40, 62).

The rings (64) are mounted around the end of the shaft (63).

The commutator (51)(65) may be a band and is mounted around the end of the shaft (30)(63) and may have a side and wires. The wires are connected the commutator (65) and the rings (64).

The cord (50, 70) is mounted on the side of the shaft (30, 63) and between the magnetic pieces (41) of the rotor (40, 62) and may be connected to the commutator (51) or the rings (64).

The brushes (52) are mounted on the side of the commutator (51, 65) and picks up and rectifies current generated in the cord (50, 70) when the shaft (30, 63) rotates.

Due to the polarity repelling between the stator (20, 61) and the rotor (40, 62), the repelling force from the stator (20, 61) to the rotor (40, 62) drives the rotor (40, 62) to rotate, which drives the shaft (30, 63) to rotate simultaneously.

During the rotation, the magnetic fields between the stator (20, 61) and the rotor (40, 62) make the cord (50, 70) to generate the current or others. The current will transmit to the commutator (51) or the rings (64). The rings (64) will pass the electricity to the commutator (65). The brushes (52) pick up and rectifies the current. The current can be used or saved in the battery. Part of the current will transmit back to the rotor (40, 62) or the stator (20, 61) to increase the magnetic fields of the rotor (40, 62) or the stator (20, 61) to accelerate the rotation of the shaft (30, 63) so that the rotatable magnetic device may generate more current or speed up some device that connects to the rotatable magnetic device.

From structures described above, the rotation of the shaft (30, 63) depends on the magnetic repelling of the stator (20, 61) and the rotor (40, 62) so that the shaft (30, 63) may rotate without an external force. Because no external force is required so that no power source is wasted during the shaft (30, 63) rotates. Furthermore, the rotatable magnetic device may be widely used in a continued rotation device such as a generator, traffic devices or household appliances.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A rotatable magnetic device comprising a housing be hollow and having an inner wall;
a stator having
multiple magnetic pieces, each magnetic piece mounted on the inner wall of the housing and having a side wall;
a shaft mounted coaxially and rotatably in the housing and having
an end;
a side; and
a center;
a rotor having
multiple magnetic pieces, each magnetic piece mounted around the side of the shaft, corresponded to the center of the shaft with certain degrees slanting, being not alignment to each other and corresponding to the magnetic pieces of the stator and having a side wall;
a coil wounded on the side walls of the magnetic pieces of the stator and the side walls of the magnetic pieces of the rotor; and
a cord mounted on the side of the shaft and between the magnetic pieces of the rotor;
whereby, a rotational torque applied to the shaft is generated due to a location of the rotor relative to the shaft so that the rotor drives the shaft to rotate simultaneously.

2. The rotatable magnetic device as claimed in claim 1 further having a commutator mounted around the end of the shaft, connected to the cord and having a side; and
multiple brushes mounted on the side of the commutator.

3. The rotatable magnetic device as claimed in claim 1 further having multiple rings mounted around the end of the shaft and connected to the cord;
a commutator mounted around the end of the shaft and having
a side; and
multiple wires connected to the commutator and the rings; and
multiple brushes mounted on the side of the commutator.

4. The rotatable magnetic device as claimed in claim 2, wherein the commutator is a band.

5. The rotatable magnetic device as claimed in claim 3, wherein the commutator is a band.
